(19) United States
(12) Patent Application Publication
(10) Pub. No.: US 2024/0113309 A1
(43) Pub. Date: Apr. 4, 2024

(54) FUEL CELL SYSTEM

(71) Applicant: TOYOTA JIDOSHA KABUSHIKI KAISHA, Toyota-shi (JP)

(72) Inventors: Masayuki ITO, Shizuoka-ken (JP); Masaaki MATSUSUE, Mishima-shi (JP); Yumiko TSUGAWA, Nagareyama-shi (JP)

(21) Appl. No.: 18/358,996

(22) Filed: Jul. 26, 2023

(30) Foreign Application Priority Data
Sep. 29, 2022 (JP) 2022-155732

(51) Int. Cl. H01M 8/04089; H01M 8/04082

(52) U.S. Cl. CPC H01M 8/04097; H01M 8/04201

(57) ABSTRACT

A fuel cell system that recirculates fuel off gas that has not been used for power generation of a fuel cell is provided. The fuel cell system includes a fuel cell stack, a fuel container, a fuel supply path, and a fuel circulation path. The fuel circulation path is connected to a fuel outlet of the fuel cell stack and extends parallel to an end plate of the fuel cell stack. The fuel supply path is connected to the fuel container, extends parallel to the end plate, and merges with the fuel circulation path at a position where a center of the fuel supply path is offset from a center of the fuel circulation path. The fuel circulation path includes a bent portion downstream of a merging portion with the fuel supply path, and is connected to a fuel inlet of the fuel cell stack downstream of the bent portion.

### CROSS-REFERENCE TO RELATED APPLICATION

This application claims priority to Japanese Patent Application No. 2022-155732 filed on Sep. 29, 2022, incorporated herein by reference in its entirety.

### BACKGROUND

### 1. Technical Field

The present disclosure relates to a fuel cell system.

### 2. Description of Related Art

Various studies have been made on a fuel cell (FC).

For example, in Japanese Unexamined Patent Application Publication No. 2018-106877 (JP 2018-106877 A), a pipe shape is disclosed in which anode gas (fuel gas) supplied from the hydrogen tank and anode off gas (fuel off gas) discharged from the fuel cell stack are connected to a merging flow path from opposite directions.

### SUMMARY

Due to restrictions on mounting a fuel cell system, it may not be possible to adopt a structure in which the fuel gas and the fuel off gas are caused to flow in from opposite directions.

The present disclosure has been made in view of the above circumstances, and a main object of the present disclosure is to provide a fuel cell system through which downsizing of the fuel cell system is compatible with agitating of fuel after merging the fuel gas and the fuel off gas.

In the present disclosure, a fuel cell system configured to recirculate fuel off gas that has not been used for power generation of a fuel cell is provided. The fuel cell system includes a fuel cell stack, a fuel container, a fuel supply path, and a fuel circulation path. The fuel circulation path is connected to a fuel outlet of the fuel cell stack and extends parallel to an end plate of the fuel cell stack. The fuel supply path is connected to the fuel container, extends parallel to the end plate, and merges with the fuel circulation path at a position in which a center of the fuel supply path is offset from a center of the fuel circulation path. The fuel circulation path includes a bent portion downstream of a merging portion with the fuel supply path, and is connected to a fuel inlet of the fuel cell stack downstream of the bent portion.

In the fuel cell system according to the present disclosure, in the fuel circulation path, a hydrogen pump is disposed upstream of the merging portion, and in the fuel supply path, an injector is disposed upstream of the merging portion.

The present disclosure can provide a fuel cell system through which downsizing of the fuel cell system is compatible with agitating of fuel after the merging.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram of a fuel gas system connected to a fuel cell stack as viewed from an end plate 11 side of the fuel cell stack to which fuel gas system components are attached;

FIG. 2 is a diagram of the fuel cell system of FIG. 1 as viewed from above;

FIG. 3 is a diagram showing hydrogen concentration distribution in a fuel passage when calculated under a predetermined condition, with respect to a pipe (A) and a pipe (B); and

FIG. 4 is a diagram showing the hydrogen concentration distribution immediately after a fuel supply path 22 in the fuel passage merges a fuel circulation path 21 and before the fuel circulation path 21 bends, with respect to the pipe (A) and the pipe (B).

### DETAILED DESCRIPTION OF EMBODIMENTS

Embodiments according to the present disclosure will be described below. It should be noted that matters other than those specifically mentioned in the present specification and necessary to carry out the present disclosure (for example, general configurations and manufacturing processes of a fuel cell system that do not characterize the present disclosure) may be regarded as design matters for those skilled in the art based on the related art in the field. The present disclosure may be carried out based on the content disclosed in the present specification and the common general technical knowledge in the field. Also, the dimensional relationships (length, width, thickness, etc.) in the drawings do not reflect the actual dimensional relationships. In the present specification, the term “to” indicating a numerical range is used in the sense of including the numerical values described before and after the term as a lower limit value and an upper limit value. Any combination of the upper limit value and the lower limit value in the numerical range can be adopted.

In the present disclosure, a fuel cell system configured to recirculate fuel off gas that has not been used for power generation of a fuel cell is provided. The fuel cell system includes a fuel cell stack, a fuel container, a fuel supply path, and a fuel circulation path. The fuel circulation path is connected to a fuel outlet of the fuel cell stack and extends parallel to an end plate of the fuel cell stack. The fuel supply path is connected to the fuel container, extends parallel to the end plate, and merges with the fuel circulation path at a position in which a center of the fuel supply path is offset from a center of the fuel circulation path. The fuel circulation path includes a bent portion downstream of a merging portion with the fuel supply path, and is connected to a fuel inlet of the fuel cell stack downstream of the bent portion.

In the present disclosure, fuel gas and oxidant gas are collectively referred to as reactant gas. The reactant gas supplied to an anode is the fuel gas (anode gas), and the reactant gas supplied to a cathode is the oxidant gas (cathode gas). The fuel gas is gas containing primarily hydrogen, and may be hydrogen. The oxidant gas is gas containing oxygen, and may be air or the like. The reactant gas discharged from the anode is fuel off gas (anode off gas), and the reactant gas discharged from the cathode is oxidant off gas (cathode off gas). In the present disclosure, the fuel gas and the fuel off gas are collectively referred to as fuel.

In JP 2018-106877 A, a supply flow path and a circulation flow path are merged from opposite directions and connected. The supply flow path extends from an injector that injects fuel, and the circulation flow path extends form a fuel pump for circulating and pumping the fuel. For both the injector and the fuel pump, when liquid water enters and accumulates in the injector and the fuel pump, the flow of gas may be hindered. Therefore, it is desirable that both the circulation flow path and the supply flow path are merged from a high position, and thus, it may be difficult to merge the circulation flow path and the supply flow path extending from the opposite directions. Even in a case where the circulation flow path and the supply flow path extend from the same direction and merge, gas containing generated water generated by power generation of the fuel cell flows through the circulation flow path. Therefore, it is needed to appropriately mix hydrogen gas that flows through the supply flow path with gas containing a large amount of impurities other than hydrogen gas that flows in the circulation flow path.

According to the present disclosure, the fuel supply path merges with the fuel circulation path at a position in which the center of the fuel supply path is offset from the center of the fuel circulation path, and as a result, hydrogen concentration distribution in the fuel passage is generated in a direction parallel to the end plate, and by passing through a bent portion thereafter, gas on the inner side of the bent portion and gas on the outer side of the bent portion are agitated, so that the distribution becomes uniform. Thus, hydrogen that is the fuel gas is evenly supplied to each fuel-cell cell. Since both the fuel circulation path and the fuel supply path extend in parallel with the end plate, an amount of protrusion of the fuel passage from the fuel cell stack can be kept small, and the overall size of the fuel cell system can be kept small.

The fuel cell system recirculates fuel off gas that has not been used for power generation of the fuel cell. The fuel cell system includes, as a fuel cell, a fuel cell stack that is a stack in which multiple fuel-cell cells are stacked together. In the present disclosure, both the fuel-cell cell and the fuel cell stack may be referred to as a fuel cell. The number of the fuel-cell cells stacked is not particularly limited, and may be, for example, two to several hundred.

The fuel-cell cell includes at least a membrane electrode gas diffusion layer assembly. The membrane electrode gas diffusion layer assembly includes an anode-side gas diffusion layer, an anode catalyst layer, an electrolyte membrane, a cathode catalyst layer, and a cathode-side gas diffusion layer in this order.

The cathode (oxidant electrode) includes the cathode catalyst layer and the cathode-side gas diffusion layer. The anode (fuel electrode) includes the anode catalyst layer and the anode-side gas diffusion layer. The cathode catalyst layer and the anode catalyst layer are collectively referred to as a catalyst layer. Examples of an anode catalyst and a cathode catalyst include platinum (Pt) and ruthenium (Ru), and examples of a carrier that supports a catalyst include carbon materials such as carbon and the like.

The cathode-side gas diffusion layer and the anode-side gas diffusion layer are collectively referred to as a gas diffusion layer. The gas diffusion layer may be an electroconductive member or the like having gas permeability. Examples of the electroconductive member include porous carbon bodies such as carbon cloth and carbon paper, and porous metal bodies such as metal mesh and metal foam.

The electrolyte membrane may be a solid polymer electrolyte membrane. Examples of the solid polymer electrolyte membrane include fluorine-based electrolyte membranes such as perfluorosulfonic acid thin films containing water, and hydrocarbon-based electrolyte membranes. As the electrolyte membrane, for example, a Nafion membrane (produced by DuPont) may be used.

The fuel-cell cell may include two separators sandwiching both sides of the membrane electrode gas diffusion layer assembly, as required. One of the two separators is an anode-side separator and the other one of the two separators is a cathode-side separator. In the present disclosure, the anode-side separator and the cathode-side separator are collectively referred to as a separator. The separator may have a hole constituting a manifold, such as a supply hole and a discharge hole for circulating a fluid such as the reactant gas and a cooling medium in a stacking direction of unit cells. As the cooling medium, for example, a mixed solution of ethylene glycol and water can be used to suppress freezing at low temperatures. Further, cooling air can be used as the cooling medium. Examples of the supply hole include a fuel gas supply hole, an oxidant gas supply hole, a cooling medium supply hole, and the like. Examples of the discharge hole include a fuel gas discharge hole, an oxidant gas discharge hole, a cooling medium discharge hole, and the like. The separator may have a reactant gas flow path on a surface that is in contact with the gas diffusion layer. Moreover, the separator may have a cooling medium flow path for keeping the temperature of the fuel cell constant, on a surface on the opposite side of the separator from the surface that is in contact with the gas diffusion layer. The separator may be a gas-impermeable electroconductive member or the like. The electroconductive member may be, for example, dense carbon that is made to be gas-impermeable by compressing carbon, a press-molded metal (e.g., iron, aluminum, stainless steel, etc.) plate, or the like. Also, the separator may have a current collecting function.

The fuel cell stack is constituted with both ends sandwiched between end plates. One end plate out of the end plates on both ends is provided with a fuel outlet and a fuel inlet. Accordingly, the fuel cell stack includes the fuel outlet and the fuel inlet. An oxidant outlet and an oxidant inlet of the fuel cell stack may be provided on the end plate that is provided with the fuel outlet and the fuel inlet, or may be provided on the other end plate.

The fuel cell stack may have a manifold such as an inlet manifold with which each supply hole communicates and an outlet manifold with which each discharge hole communicates. Examples of the inlet manifold include a fuel inlet manifold, an oxidant inlet manifold, a cooling medium inlet manifold, and the like. Examples of the outlet manifold include a fuel outlet manifold, an oxidant outlet manifold, a cooling medium outlet manifold, and the like.

The fuel cell system includes, in the fuel gas system, a fuel container, a fuel supply path and a fuel circulation path as a fuel passage, and may be provided with a hydrogen pump, an injector, etc., as required. The fuel container may be a hydrogen tank or the like. The fuel circulation path is connected to the fuel outlet of the fuel cell stack and extends parallel to the end plate of the fuel cell stack. The fuel supply path is connected to the fuel container, extends parallel to the end plate of the fuel cell stack, and merges with the fuel circulation path at a position in which the center of the fuel supply path is offset from the center of the fuel circulation path. The fuel circulation path has a bent portion downstream of the merging portion with the fuel supply path, and is connected to the fuel inlet of the fuel cell stack downstream of the bent portion. In the fuel circulation path, a hydrogen pump may be arranged upstream of the merging portion. In the fuel supply path, an injector may be arranged upstream of the merging portion.

The fuel cell system according to the present disclosure includes a fuel gas system, and typically further includes an oxidant gas system and a cooling system. The oxidant gas system at least supplies the oxidant gas to the cathode of the fuel cell, and as required, discharges the oxidant off gas that is a reacted oxidant gas discharged from the cathode of the fuel cell, outside the oxidant gas system. The cooling system at least supplies the cooling medium to the fuel cell, and as required, circulates the cooling medium inside and outside the fuel cell, and adjusts the temperature of the fuel cell. In an air-cooled fuel cell, as the cooling system, a cooling air inlet and a cooling air outlet may be provided on the side surface of the fuel cell. For example, the fuel cell may be cooled by causing cooling air to flow from the cooling air inlet to the cooling air outlet with a cooling fan or the like.

The fuel cell system according to the present disclosure may have a control unit that controls the operation of the fuel cell. The control unit physically includes, for example, an arithmetic processing unit such as a central processing unit (CPU), a read-only memory (ROM) that stores control programs, control data, and the like processed by the CPU, and a storage device such as a random access memory (RAM) used mainly as various work areas for control processing, and an input and output interface. Further, the control unit may be a control device such as an electronic control unit (ECU). The control unit may be electrically connected to an ignition switch that may be mounted on a moving body such as a vehicle. The control unit may be operable by an external power source even when the ignition switch is turned off.

The fuel cell system according to the present disclosure may be used by being mounted on a moving body such as a vehicle. Also, the fuel cell system according to the present disclosure may be used by being mounted on a generator that supplies electric power to the outside. The vehicle may be a fuel cell electric vehicle or the like. The moving body other than the vehicle includes, for example, railroads, ships, aircraft, and the like. Further, the fuel cell system according to the present disclosure may be used by being mounted on a moving body such as a vehicle that is able to travel also on the electric power of a secondary battery. The moving body may be provided with the fuel cell system according to the present disclosure. The moving body may include a drive unit such as a motor, an inverter, and a hybrid control system. The hybrid control system may be a system that is able to make the moving body travel using both an output of the fuel cell and the electric power of the secondary battery.

### First Embodiment

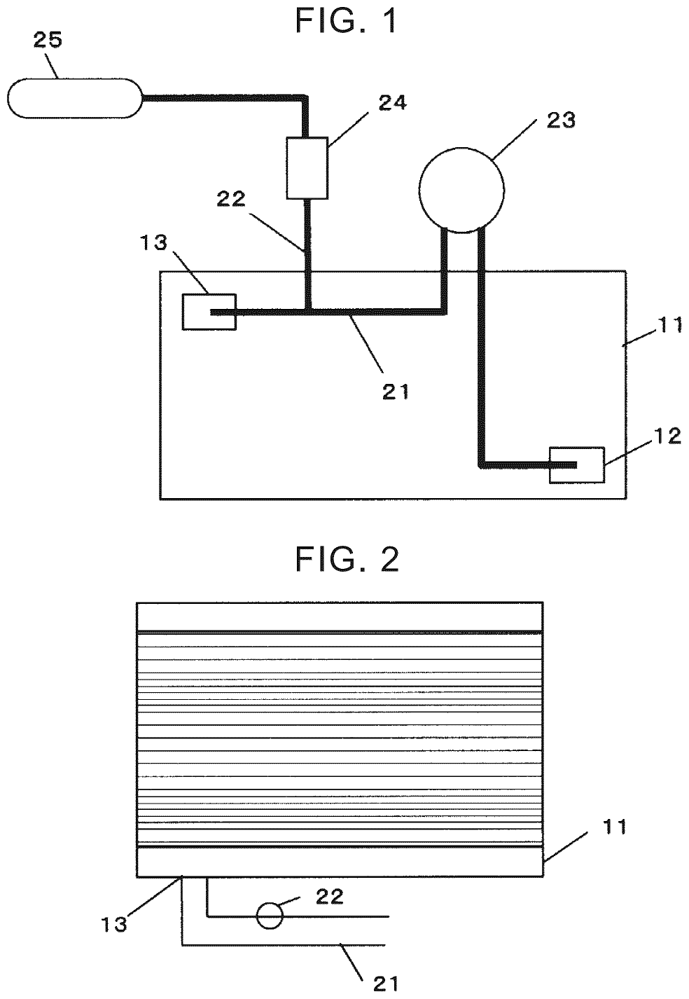

FIG. 1 is a diagram of the fuel gas system connected to the fuel cell stack as viewed from the end plate 11 side of the fuel cell stack to which fuel gas system components are attached, that is a stack manifold side. The fuel cell stack is constituted with multiple fuel-cell cells being stacked and both ends being sandwiched between the end plates. One end plate 11 out of the end plates on both ends is provided with the fuel outlet 12 and the fuel inlet 13. The fuel outlet 12 and the fuel inlet 13 are connected via the fuel circulation path 21 and the hydrogen pump 23, and the gas discharged from the fuel outlet 12 is supplied again to the fuel cell stack. The fuel supply path 22 is connected to the fuel circulation path 21 in the middle of the fuel circulation path 21, and hydrogen that is the fuel gas is supplied to the fuel cell from the hydrogen tank 25 via the injector 24. Here, the fuel gas supplied from the fuel supply path 22 is hydrogen containing almost no impurities, whereas the fuel off gas supplied from the fuel circulation path 21 is a mixed gas including surplus hydrogen not used for power generation of the fuel cell, nitrogen gas permeated from the cathode side of the fuel cell, and water or water vapor produced by the power generation of the fuel cell. When the gas is supplied to the fuel cell from the fuel inlet 13, and the gas is not sufficiently mixed, the amount of hydrogen supplied to each cell of the fuel cell becomes ununiform, and a cell to which hydrogen is not supplied enough may appear. As to the cell to which hydrogen is not supplied enough, power generation performance may be reduced or the fuel cell may be deteriorated.

FIG. 2 is a diagram of the fuel cell system of FIG. 1 as viewed from above. In FIG. 2, some of the components shown in FIG. 1 are not shown for convenience. As shown in FIG. 2, the fuel circulation path 21 extends parallel to the end plate 11 and then bends to be connected to the fuel inlet 13. As a result, the amount of protrusion of the fuel passage from the fuel cell stack is reduced, and the size can be reduced. The fuel supply path 22 indicated by a circle extends in the direction perpendicular to the paper surface of the drawing and merges with the fuel circulation path 21. Also here, the amount of protrusion of the fuel passage from the fuel cell stack is kept small, and the size is reduced. The fuel supply path 22 merges with the fuel circulation path 21 at a position in which the center of the fuel supply path 22 is offset from the center of the fuel circulation path 21.

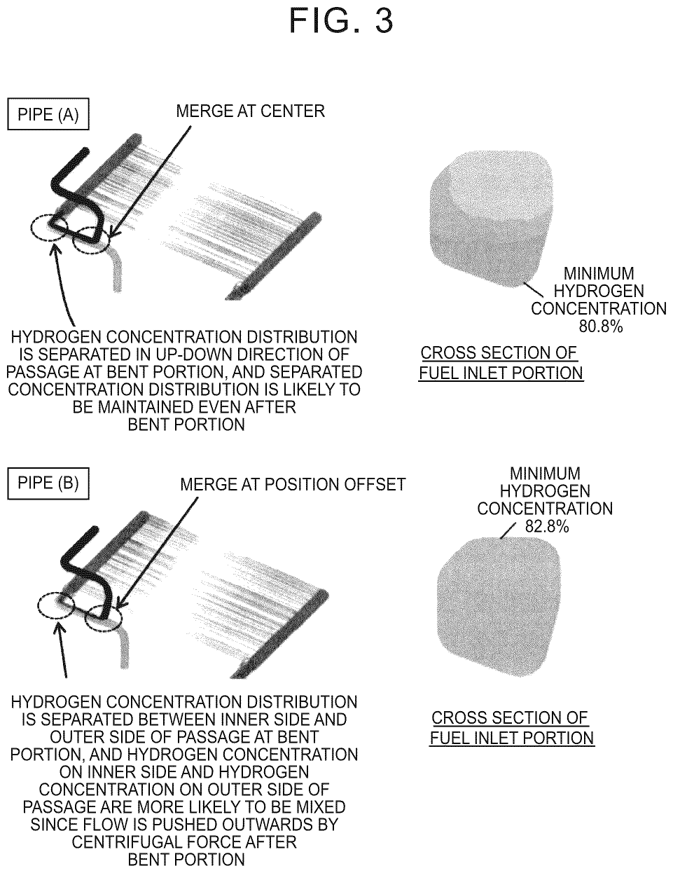

FIG. 3 is a diagram showing the hydrogen concentration distribution in the fuel passage when calculated under a predetermined condition, with respect to a pipe (A) and a pipe (B). In FIG. 3, the left side of the fuel cell stack has a high hydrogen concentration, and the hydrogen concentration decreases toward the right side. The pipe (A) shown on the upper left side of FIG. 3 indicates a case in which the center of the fuel circulation path 21 coincides with the center of the fuel supply path 22, and the pipe (B) shown on the lower left side of FIG. 3 indicates a case in which the center of the fuel supply path 22 is offset from the center of the fuel circulation path 21. In the pipe (A), the hydrogen concentration distribution is separated between the upper side and the lower side (in the up-down direction) of the passage at the bent portion. Thus, the separated concentration distribution is likely to be maintained even after the bent portion. In the pipe (B), the hydrogen concentration distribution is separated between the inner side and the outer side (in the right-left direction) of the passage at the bent portion. Thus, the hydrogen concentration on the inner side and the hydrogen concentration on the outer side of the passage are more likely to be mixed since the flow is pushed outwards by centrifugal force after the bent portion. In the pipe (A), as shown on the upper right side of FIG. 3, the hydrogen concentration in the cross section of the fuel inlet portion is not uniform, and the value of the minimum hydrogen concentration is as low as 80.8%. On the other hand, in the pipe (B), as shown on the lower right side of FIG. 3, the hydrogen concentration in the cross section of the fuel inlet portion is uniform, and the value of the minimum hydrogen concentration is as high as 82.8%. As a result, hydrogen can be more uniformly supplied to each fuel-cell cell, and the occurrence of failure due to shortage of hydrogen can be suppressed.

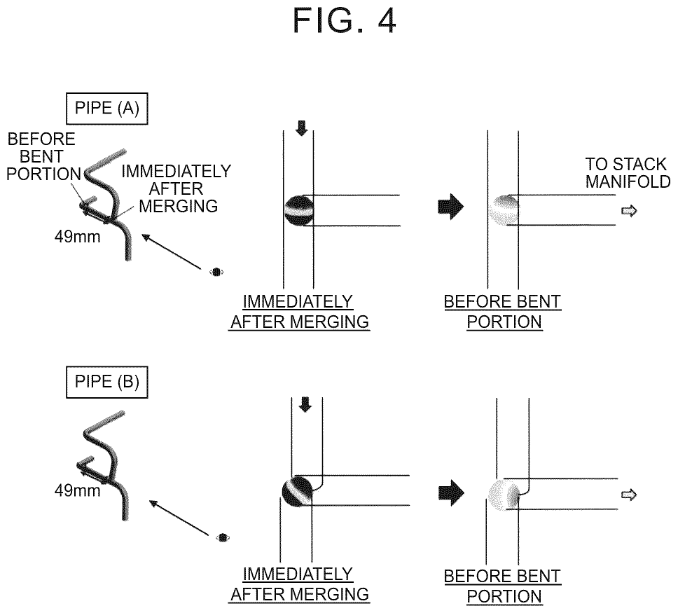

FIG. 4 is a diagram showing the hydrogen concentration distribution immediately after the fuel supply path 22 in the fuel passage merges with the fuel circulation path 21 and before the fuel circulation path 21 bends, with respect to the pipe (A) and the pipe (B). In the pipe (A) shown on the upper left side of FIG. 4, the center of the fuel supply path 22 coincides with the center of the fuel circulation path 21, and the fuel supply path 22 merges with the fuel circulation path 21 from the upper portion of the drawing. Thus, as shown in the upper center portion of FIG. 4, the hydrogen concentration distribution can be seen in the up-down direction of the passage immediately after merging. The above tendency is the same for both immediately after the merging and before the bent portion as shown on the upper right side of FIG. 4. Two kinds of hydrogen concentration distribution shown in the upper center portion of FIG. 4 and the upper right side of FIG. 4 are views of the pipe (A) on the upper left side of FIG. 4 when viewed from the marked point in the direction of the arrow. On the other hand, in the pipe (B) shown on the lower left side of FIG. 4, the fuel supply path 22 merges with the fuel circulation path 21 with the center of the fuel supply path 22 being offset to the right side with respect to the center of the fuel circulation path 21. Thus, as shown in the lower center portion of FIG. 4, the hydrogen concentration distribution can be seen in the right-left direction of the passage immediately after the merging. The above tendency is the same for both immediately after the merging and before the bent portion as shown on the lower right side of FIG. 4. Two kinds of hydrogen concentration distribution shown in the lower center portion of FIG. 4 and the lower right side of FIG. 4 are views of the pipe (B) on the lower left side of FIG. 4 when viewed from the marked point in the direction of the arrow. In the bent portion, the gas flows less easily on the inner side of the bent portion and the gas flows more easily on the outer side of the bent portion. Thus, the gas on the inner side and the gas on the outer side of the bent portion are mixed. In the pipe (B), the hydrogen concentration distribution before the bent portion is separated between the inner side and the outer side of the bent portion. Therefore, it is conceivable that mixing occurs at the bent portion and the concentration is uniform downstream of the bent portion. On the other hand, in the pipe (A), the hydrogen concentration distribution before the bent portion is separated between the upper side and the lower side of the bent portion. Therefore, it is conceivable that mixing does not occur at the bent portion, and a state in which the hydrogen concentration is ununiform is maintained even downstream of the bent portion.

### OTHER EMBODIMENTS

The stacking direction of the fuel-cell cells is not particularly limited. As shown in FIG. 1 and FIG. 2, the fuel-cell cells may be stacked in an upright state, or may be vertically stacked in a laid down state. When the fuel-cell cells are stacked vertically in the laid down state, the end plate 11 may be arranged to be under the fuel-cell cells from the viewpoint of suppressing liquid water from remaining in the fuel cell stack. The fuel circulation path 21 extending from the hydrogen pump 23 and the fuel supply path 22 extending from the injector 24 may extend from the same direction or extend from opposite directions. When the fuel-cell cells are stacked in the upright state, from the viewpoint of suppressing the liquid water flowing in the fuel circulation path 21 from flowing into the hydrogen pump 23 and the injector 24 to inhibit the flow of the fuel, the fuel circulation path 21 and the fuel supply path 22 may be connected so as to extend from above. The direction of the center of the fuel supply path 22 being offset from the center of the fuel circulation path 21 may be either closer to the end plate 11 or farther from the end plate 11. In either case, the hydrogen concentration distribution occurs parallel to the end plate 11 after the merging, and the gas on the inner side of the bent portion and the gas on the outer side of the bent portion are agitated at the bent portion, and the hydrogen concentration distribution is uniform downstream of the bent portion.

What is claimed is:

1. A fuel cell system configured to recirculate fuel off gas that has not been used for power generation of a fuel cell, wherein:
the fuel cell system includes a fuel cell stack, a fuel container, a fuel supply path, and a fuel circulation path;
the fuel circulation path is connected to a fuel outlet of the fuel cell stack and extends parallel to an end plate of the fuel cell stack;
the fuel supply path is connected to the fuel container, extends parallel to the end plate, and merges with the fuel circulation path at a position in which a center of the fuel supply path is offset from a center of the fuel circulation path; and
the fuel circulation path includes a bent portion downstream of a merging portion with the fuel supply path, and is connected to a fuel inlet of the fuel cell stack downstream of the bent portion.

2. The fuel cell system according to claim 1, wherein:
in the fuel circulation path, a hydrogen pump is disposed upstream of the merging portion; and
in the fuel supply path, an injector is disposed upstream of the merging portion.
